(19) United States
(12) Patent Application Publication
(10) Pub. No.: US 2015/0298631 A1
(43) Pub. Date: Oct. 22, 2015

(54) ELECTRIC TRANSPORTATION MEANS, ASSOCIATED METHOD AND ASSOCIATED RECHARGEABLE BATTERY

(71) Applicant: SIEMENS AKTIENGESELLSCHAFT, München (DE)

(72) Inventors: Andreas Belger, Lauf (DE); Bernhard Fischer, Toging A. Inn (DE); Gunter Freitag, Munchen (DE); Thomas Schmid, Leinfelden-Echterdingen (DE)

(21) Appl. No.: 14/440,908

(22) PCT Filed: Sep. 16, 2013
(86) PCT No.: PCT/EP2013/069104

§ 371 Date: May 6, 2015

(30) Foreign Application Priority Data
Nov. 12, 2012 (DE) 10 2012 220 549.7

(51) Int. Cl. B60R 16/033; B60L 11/18

(52) U.S. Cl. CPC B60R 16/033; B60L 11/1861

(57) ABSTRACT

An electric transportation means, in particular an electric vehicle including: an accumulator unit including a first connection and including a second connection wherein between the first connection and the second connection a first voltage of at least 200 volts is applied when the accumulator unit is fully charged, and includes a third connection, wherein a second voltage is tapped on the third connection, said voltage being less than 20% or less than 10% or less than 5% of the first voltage, and an on-board power supply that is connected to the third connection and that can be connected via a first switch unit of the transportation means is provided.

### CROSS-REFERENCE TO RELATED APPLICATIONS

This application claims priority to PCT Application No. PCT/EP2013/069104, having a filing date of Sep. 16, 2013, based off of German Application No. DE 102012220549.7, having a filing date of Nov. 12, 2012, the entire contents of which are hereby incorporated by reference.

### FIELD OF TECHNOLOGY

The following relates to an electric transportation means, an associated method and an associated rechargeable battery.

### BACKGROUND

The electric transportation means includes in particular electric vehicles, electric cars, electric ships, electric airplanes, electric trucks, electric scooters and electric motorbikes. A common feature of the electric transportation means is that an electric motor is used as drive, which is fed from a traction battery or from a rechargeable traction battery. There is the possibility of charging this rechargeable battery with energy from alternative energy sources, for example solar energy, wind energy or energy from biowaste.

### SUMMARY

Embodiments of the invention relates to an electric transportation means, in particular an electric vehicle, comprising:
a rechargeable battery unit comprising a first connection and a second connection at the rechargeable battery unit, wherein, when the rechargeable battery unit is fully charged, a first voltage of at least 200 volts is present between the first connection and the second connection, and comprising a third connection at the rechargeable battery unit, wherein a second voltage which is less than 20% or less than 10% or less than 5% of the first voltage can be tapped off at the third connection, preferably between the third connection and the first connection, and
a vehicle electrical distribution system, which is connected to the third connection or is connectable to said third connection via a first switching unit of the transportation means.

In addition, embodiments of the invention relates to a method for operating a transportation means,
wherein, in a first operating mode, a vehicle electrical distribution system is operated at a connection of a rechargeable battery unit, wherein only a partial voltage of the rechargeable battery unit is present at the connection, and
wherein, in a second operating mode, the vehicle electrical distribution system is fed by a voltage converter, which is connected to a further connection of the rechargeable battery unit, wherein a voltage which is greater than the partial voltage, in particular more than twice as great, more than three times as great or more than ten times as great, is present at the further connection.

Embodiments of the invention furthermore relates to a rechargeable battery unit, comprising:
a first connection and a second connection at the rechargeable battery unit, wherein, when the rechargeable battery unit is fully charged, a first voltage of at least 200 volts is present between the first connection and a second connection, and
a third connection at the rechargeable battery unit, wherein a second voltage which is less than 20% or less than 10% or less than 5% of the first voltage can be tapped off at the third connection, preferably between the third connection and the first connection.

The electric transportation means need to be improved further still, in particular as regards the complexity involved in their manufacture. Therefore, the object of the present invention consists in specifying an electric transportation means which has a simple design and which in particular does not comprise a separate vehicle electrical distribution system rechargeable battery. In addition, an associated method and an associated rechargeable battery are specified.

An electric transportation means, in particular an electric vehicle, can comprise:
a rechargeable battery unit comprising a first connection and a second connection at the rechargeable battery unit, wherein, when the rechargeable battery unit is fully charged, a first voltage of at least 200 volts is present between the first connection and the second connection, and comprising a third connection at the rechargeable battery unit, wherein, preferably when the rechargeable battery unit is fully charged, a second voltage which is less than 20% or less than 10% or less than 5% of the first voltage can be tapped off at the third connection, and
a vehicle electrical distribution system, which is connected to the third connection or is connectable thereto via a first switching unit of the transportation means.

The rechargeable battery unit can be accommodated in a separate housing, which consists of plastic or of metal, for example. The housing can have only two, three or four external connections, in particular for high currents of, for example, greater than 1 ampere or greater than 10 amperes. For example, more than 100 individual cells, for example lithium-ion cells, can be arranged in the housing.

Thus, the voltage of the rechargeable battery unit or the rechargeable battery can be in the range of from 200 volts to 800 volts. In the case of a symmetrical voltage supply with respect to a ground terminal, the voltage can be in the range of from 200 volts to 400 volts. In the case of a simple voltage supply, i.e. a positive terminal and a negative terminal and a ground terminal, the voltage can typically be in the range of from 400 volts to 800 volts, for example. However, other voltage ranges are also possible. The second voltage can be, for example, greater than 1% of the first voltage by way of mentioning a lower limit.

The first switching unit can be part of the rechargeable battery unit, i.e. can be arranged in the rechargeable battery housing. Alternatively, the first switching unit can also be arranged outside the rechargeable battery unit in the electric transportation means.

Thus, only one single rechargeable battery unit can be provided in the electric transportation means. Alternatively, there may be a plurality of rechargeable battery units, but no rechargeable battery unit is used exclusively for feeding the vehicle electrical distribution system of the electric vehicle.

As is also the case in the text which follows, means electrically conductively connected, i.e. using a metal line, in particular a copper line, for example with twisted copper wires, for example.

The technical effect of the specified rechargeable battery unit is that a separate vehicle electrical distribution system battery or a separate vehicle electrical distribution system rechargeable battery unit is not required in addition to the mentioned rechargeable battery unit. Nevertheless, the vehicle electrical distribution system voltage can be generated in a simple manner. Thus, the number of individual parts required is reduced, which reduces production costs.

Failures of a voltage converter for generating the voltage for the vehicle electrical distribution system during driving can be bypassed for a short period of time because a second energy source for voltage supply is available, which is available independently of the voltage converter.

The direct supply of the vehicle electrical distribution system from the rechargeable battery unit, i.e. without the use of a high-voltage voltage converter, can be used, for example, only for a short period of time during starting of the transportation means. Owing to the fact that an electric transportation means generally does not have a starter motor, only comparatively low currents flow during starting, which currents only influence insubstantially the state of charge of the cells of the rechargeable battery unit between ground and the third connection.

The third connection can also be only one tap, wherein only one series circuit comprising individual cells is present in the rechargeable battery or in the rechargeable battery unit, said series circuit not being interrupted and also not being able to be interrupted with the aid of switching elements. However, this is one variant which requires possibly further measures during disconnection of the high-voltage battery/rechargeable battery, in particular during parking of the transportation means.

The following units can be operated on the vehicle electrical distribution system, for example:
central control unit, for example comprising microprocessor or microcontroller,
running light,
electrical braking system (brake by wire), in particular brake control,
electric steering (steer by wire)
air conditioning system,
radio, CD (compact disc) and/or other entertainment media,
electric window winder,
control unit and/or voltage supply unit for a secondarily clocked high-voltage voltage converter.

The following units can be operated on the driving electrical system of the electric transportation means:
traction electric motor, for example wheel hub motor,
converter for the electric motor,
control unit and/or voltage supply unit for a primarily clocked high-voltage voltage converter, which in particular enables galvanic isolation of the vehicle electrical distribution system and the driving electrical system.

A voltage converter can be connected on the input side to the second connection or can be connectable thereto via a second switching unit of the transportation means. The second switching unit can be used for isolating the high-voltage rechargeable battery unit from the supply when the transportation means is at a standstill. The voltage converter can have the voltage of the driving electrical system as input voltage, i.e. in particular a voltage of greater than 100 volts.

The voltage converter can be a DC/DC (direct current/direct current) converter. The voltage converter is also known under the name of DC-to-DC converter. The voltage converter can be a step-down converter or an inverter, which likewise steps down the input voltage in relation to an output voltage. The voltage converter can be clocked on the primary or secondary side.

The first switching unit can comprise a first changeover switching unit, whose central connection can be connected to the vehicle electrical distribution system, whose second connection can be connected to the third connection of the rechargeable battery unit, and whose third connection can be connected to an output of the voltage converter.

Therefore, switchover of the energy supply of the vehicle electrical distribution system is possible in a simple manner:
directly from the rechargeable battery unit, for example during starting of the transportation means or in the event of failure of the voltage converter, wherein a comparatively low voltage at the rechargeable battery unit or at the rechargeable battery is tapped off, for example less than 50 volts, however,
indirectly from the rechargeable battery unit, i.e. using the voltage converter, during driving of the transportation means, wherein a comparatively high voltage of the rechargeable battery unit which is also used for the transport, for example greater than 100 volts, is present at the input of the voltage converter. On the other hand, the vehicle electrical distribution system voltage is present at the output of the voltage converter.

The first changeover switching unit can be part of an electrically actuable switching unit. Thus, the first changeover switching unit can be activated automatically and/or manually, but in this case with electronic actuation. The changeover switching unit can therefore be arranged separately and at some distance from an operating element for activating the changeover switching unit.

Thus, a relay can be used which comprises a coil which generates a magnetic field, which acts directly (reed contact) or via a mechanism on a first changeover switch. Alternatively, a switching contactor is used.

Alternatively, electronic switching units or switching transistors can be used, for example a normally on switching transistor and a normally off switching transistor. In particular, power switching units are used with switching powers of, for example, greater than 10 watts or greater than 100 watts.

Power switching units are, for example, field-effect transistors (FETs) or MOSFETs (metal-oxide semiconductor FETs), IGBTs (insulated-gate bipolar transistors), etc. Given corresponding actuation, two normally off switching transistors can also be used.

The voltage converter can be self-monitoring and can output an output signal which indicates a defect in the voltage converter or an excessively low input voltage so that switchover to the direct voltage supply of the vehicle electrical distribution system from the rechargeable battery unit can be initiated by a suitable control circuit.

The first changeover switching unit can, in a first switching mode, connect the vehicle electrical distribution system to the third connection of the rechargeable battery unit. The first changeover switching unit can, in a second switching mode, connect the vehicle electrical distribution system to the output of the voltage converter.

The changeover switching unit can be part of a switching unit which comprises an activation coil which is connected at one end to the output of the voltage converter. The other end of the coil can be connected to ground, for example, i.e. to the same ground as the voltage converter. A switching unit with a simple design results.

In a de-energized position (relay) or in the first switching mode, the vehicle electrical distribution system can only be connected to the third connection or the tap of the rechargeable battery unit, but not to the output of the voltage converter. In a working position (relay) or in the second switching mode, the vehicle electrical distribution system is connected to the output of the voltage converter, but not to the third connection of the rechargeable battery unit, on the other hand. Therefore, for example, voltage compensation currents and the losses associated therewith on the vehicle electrical distribution system can be avoided.

A first central connection of a twin changeover switching unit can be connected to a first series circuit comprising individual cells of the rechargeable battery unit. A second central connection of the twin changeover switching unit can be connected to a second series circuit comprising individual cells of the rechargeable battery unit. The second series circuit can comprise different individual cells than the first series circuit.

The twin changeover switching unit can comprise two changeover switching units which are actuated by a common control signal or which are switched by a common activation element, i.e. in particular simultaneously.

The individual cells can be primary cells or galvanic elements, for example lithium-ion cells having a voltage of between 3 and 4 volts in the fully charged state.

The rechargeable battery unit or the rechargeable battery can comprise the twin changeover switching unit. Alternatively, the twin changeover switching unit can also be arranged outside the housing of the rechargeable battery, which facilitates replacement in the event of a defect, for example.

A first connection of the first changeover switching unit of the twin changeover switching unit can be fixedly connected to a first connection of the second changeover switching unit of the twin changeover switching unit, for example by means of screwing, welding, soldering, clamping, crimping, etc. In a first switching mode, the first connection of the first changeover switching unit of the twin changeover switching unit can be connected to the first central connection of the twin changeover switching unit. In the first switching mode, the first connection of the second changeover switching unit of the twin changeover switching unit can also be connected to the second central connection of the twin changeover switching unit.

The switching mode in the case of a twin changeover switch can be a switch position. In the case of power transistors, the switching mode is a specific actuation signal or a combination of actuation signals which are present simultaneously at the switching elements.

A second connection of the first changeover switching unit of the twin changeover switching unit can be connected to the third connection of the rechargeable battery unit or can form the third connection of the rechargeable battery unit.

In a second switching mode of the twin changeover switching unit, the second connection of the first changeover switching unit of the twin changeover switching unit can be connected to the first central connection of the twin changeover switching unit. In the second switching mode of the twin changeover switching unit, the second connection of the second changeover switching unit of the twin changeover switching unit can be connected to the second central connection of the twin changeover switching unit. A second connection of the second changeover switching unit of the twin changeover switching unit can be connected to ground potential.

The technical effect can consist in that, in the first switch position or in the first switching mode, a low voltage for the vehicle electrical distribution system is present at the third connection of the rechargeable battery unit. The high-voltage side can be connected to the driving electrical system in the first switch position.

In the second switch position or in the second switching mode, on the other hand, the vehicle electrical distribution system can be disconnected from the rechargeable battery unit, in particular in respect of a terminal which differs from the ground terminal. The rechargeable battery unit in the second switch position is connected to a driving electrical system of the vehicle, in particular to a drive unit and an electrical drive motor. A voltage converter can, in the second switch position, generate the vehicle electrical distribution system voltage, i.e. indirectly from the rechargeable battery unit. The second switch position therefore relates to driving.

In the rechargeable battery unit, in particular in a housing of the rechargeable battery unit, there may also be an electronic battery management system, which can be included in the actuation of the switching units.

In one configuration, the twin changeover switching unit can be contained in the rechargeable battery unit, wherein preferably the twin changeover switching unit is electronically activated. Alternatively, the twin changeover switching unit is also arranged outside the rechargeable battery unit, wherein the rechargeable battery unit can have connections for the twin changeover switching unit, in particular in addition to at least two further connections, for example in addition to a ground terminal and a positive terminal.

Alternatively, a central connection of a changeover switching unit can be connected to a first series circuit comprising individual cells of the rechargeable battery unit. A first connection of the changeover switching unit can be connected to the third connection of the rechargeable battery unit or can form the third connection of the rechargeable battery unit. A second connection of the changeover switching unit can be connected to a second series circuit comprising individual cells of the rechargeable battery unit, wherein the second series circuit can comprise different individual cells than the first series circuit.

The technical effect consists in that, in a first switching mode or de-energized mode in the case of a relay, the vehicle electrical distribution system is connected to the first series circuit comprising individual cells, while the remaining cells of the rechargeable battery unit are electrically disconnected from the vehicle electrical distribution system.

In a second switching mode or in the working position in the case of a relay or switching contactor, on the other hand, the vehicle electrical distribution system cannot be connected directly to the rechargeable battery. The rechargeable battery unit can be connected to a high-voltage electrical system or driving electrical system of the transportation means in the second switching mode, on the other hand. A voltage converter can also be provided on this driving electrical system, said voltage converter supplying a reduced vehicle electrical distribution system voltage in comparison with the driving electrical system voltage to the vehicle electrical distribution system.

The changeover switching unit can be a changeover switch or comprise electronic switching elements, in particular semiconductor components such as transistors. The changeover switching unit can be arranged in the rechargeable battery unit or outside the rechargeable battery unit.

The changeover switching unit can, in one configuration, be contained in the rechargeable battery unit, wherein the changeover switching unit can preferably be activated electronically. Alternatively, the changeover switching unit can also be arranged outside the rechargeable battery unit, in which case corresponding additional connections for connecting the changeover switching unit can be provided at the rechargeable battery unit between two series circuits comprising individual cells of the rechargeable battery unit.

In a next alternative, the rechargeable battery unit can comprise a first series circuit comprising individual cells of the rechargeable battery unit. The first series circuit can be connected to the third connection of the rechargeable battery unit. The rechargeable battery unit can comprise a second series circuit comprising individual cells of the rechargeable battery unit. The second series circuit can comprise different individual cells than the first series circuit. One end of the second series circuit can be connected to the second connection of the rechargeable battery unit. The rechargeable battery unit and the transportation means can be free of a switching unit which connects the first series circuit to the second series circuit, in particular apart from a charging mode of the rechargeable battery or rechargeable battery unit.

The technical effect consists in that some of the cells of the rechargeable battery unit can be used for the vehicle electrical distribution system in a simple manner, in particular exclusively for the vehicle electrical distribution system and not for the driving electrical system. The other cells of the rechargeable battery unit or other cells of the rechargeable battery unit can be used for the driving electrical system. Thus, the number of rechargeable battery units is reduced despite the presence of a vehicle electrical distribution system rechargeable battery part or a driving electrical system rechargeable battery part.

In one configuration, the first series circuit comprising individual cells can be connected to a ground line of the transportation means. The ground line can be the negative terminal or in some countries also the positive terminal.

Electrical isolation in the vehicle electrical distribution system can be simple since only a comparatively low voltage needs to be isolated on the vehicle electrical distribution system, in particular in comparison with a tap of the vehicle electrical distribution system voltage on the high-voltage side of the rechargeable battery unit.

In the rechargeable battery unit, also at least three series circuits comprising individual cells of the rechargeable battery unit can be included, whose connections are passed to the outside or which can be interconnected in different ways in the rechargeable battery unit, for example disconnected or interconnected in pairs.

Thus, a driving electrical system with a symmetrical voltage supply can be used, in which there is a positive terminal and a negative terminal with respect to a ground line. As a result, the electrical insulation of the lines of the driving electrical system can be designed for lower isolation voltages.

The vehicle electrical distribution system can likewise have a symmetrical voltage supply or else can only be tapped on one side with respect to the ground line.

Instead of a driving electrical system having a symmetrical voltage supply or in addition to a driving electrical system having a symmetrical voltage supply, a plurality of series circuits comprising individual cells of the rechargeable battery unit can also be provided, which are optionally used for feeding the vehicle electrical distribution system, for example in order to increase the error redundancy or in order to reduce additional wear of the cells on the basis of utilization in the vehicle electrical distribution system and in the driving electrical system.

In a method for operating transportation means, in a first operating mode, a vehicle electrical distribution system can be operated at a connection of a rechargeable battery unit. Only a partial voltage of the rechargeable battery unit can be present at the connection. In a second operating mode, the vehicle electrical distribution system can be fed by a voltage converter, which is connected to a further connection of the rechargeable battery unit, wherein a voltage which is greater than the partial voltage, in particular more than twice as great, more than three times as great or more than ten times as great, is present at the further connection. The voltage at the further connection is, for example, less than 100 times as great as the partial voltage, however.

It is possible in the method for the electric transportation means in accordance with the above-explained embodiments to be used so that the technical effects mentioned there also apply to the method and its developments.

A rechargeable battery unit can comprise:
a first connection and a second connection at the rechargeable battery unit, wherein, when the rechargeable battery unit is fully charged, a first voltage of at least 200 volts is present between the first connection and the second connection, and
a third connection at the rechargeable battery unit, wherein, in particular when the rechargeable battery unit is fully charged, a second voltage which is less than 20 percent or less than 10 percent or less than 5 percent of the first voltage can be tapped off at the third connection.

The abovementioned technical effects likewise apply to the rechargeable battery unit or the developments thereof. In particular, the rechargeable battery unit mentioned there can also be used outside an electric transportation means or electric car, for example during sales and distribution, during maintenance and/or for other applications as electric transportation means.

The rechargeable battery unit or the rechargeable battery enables the use of transportation means with full supply from the high-voltage battery.

In other words, an electric vehicle with full supply from the high-voltage battery is explained, inter alia.

At present “normally” mass-produced vehicles in which the individual components of the drive train are replaced by their electrical counterpart are used as the basis for present-day electric transportation means or present-day electric vehicles. That is to say that, for example, the internal combustion engine is replaced by electric machines (electric motors), the tank is replaced by the battery, and the generator is replaced by a DC/DC (direct current/direct current) converter. In this case, the conventional low-voltage electrical system with its 12 volt battery, for example, for supplying the control devices remains unchanged.

This results in a situation whereby a vehicle with an empty battery, for example an empty 12 volt battery, cannot be started despite a sufficiently charged high-voltage battery. This is because, for example, in order to activate the control electronics of the DC/DC converter, the 12 volt electrical system is required. In such a case, for example, it is also no longer possible to activate the DC/DC converter by means of a typical charging station.

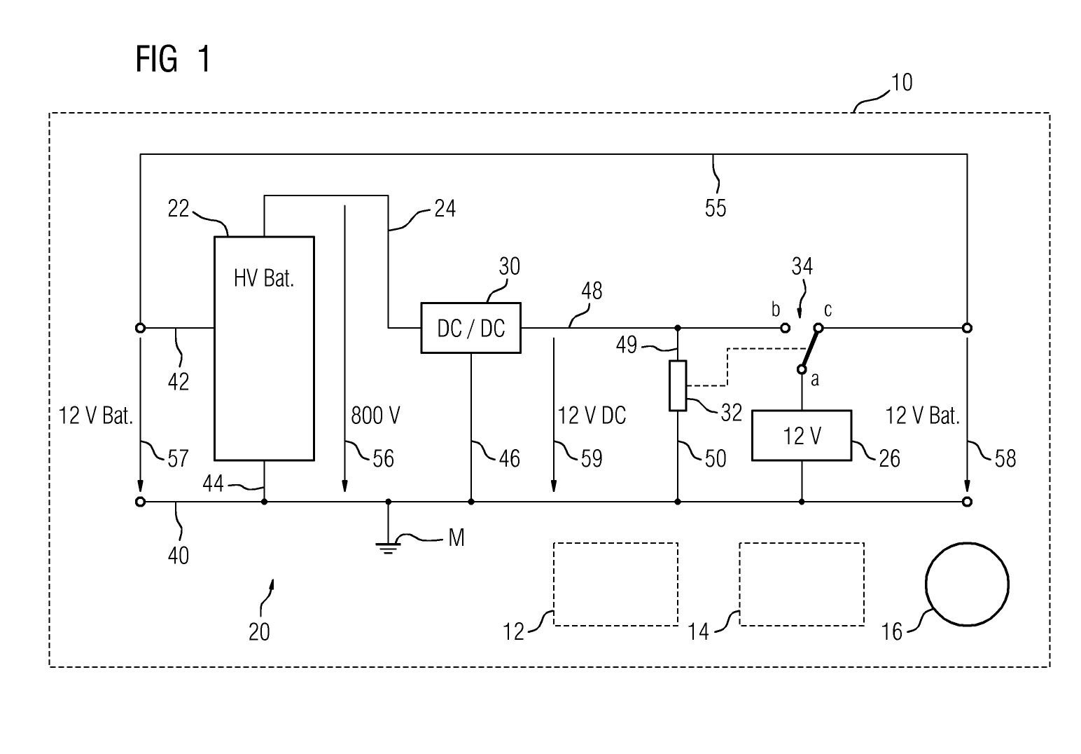

The principle design is illustrated in FIG. 1. Until now, all known electric vehicles have used, in addition to the high-voltage battery, a conventional 12 volt battery for the support of the low-voltage electrical system, for example. If the 12 volt battery fails, no driving operation is possible anymore. This results in the situation whereby some drivers always carry chargers or reserve rechargeable batteries with them.

The idea is to make the potential of the high-voltage battery usable for 12 volt applications or low-voltage applications. As a result, it is possible to dispense with the low-voltage battery, for example the 12 volt battery, entirely.

An element is in this case the DC/DC converter. Said DC/DC converter generates a constant low voltage, usually 12 V, for example, for supplying the vehicle electrical distribution system from the variable high voltage of the drive battery. The DC/DC converter has until now been used as a counterpart to the generator.

By virtue of the intelligent use of the high-voltage battery, it is thus possible to dispense with the low-voltage battery, for example 12 volt battery, entirely, as has already been mentioned above.

This is because ultimately there are two relevant scenarios in the case of an electric vehicle, for example. By virtue of embodiments of the invention or developments, it is ensured that all situations can manage without low-voltage battery, for example 12 volt battery.

Scenario 1: Electric Vehicle Charged or Driven

The DC/DC converter is active during charging and supplies energy to the vehicle electrical distribution system, for example the 12 volt vehicle electrical distribution system. The HV (high-voltage) battery is operated as a single continuous segment, for example.

Scenario 2: Parking or Failure of the DC/DC Converter

Since the DC/DC converter is moderately efficient in the case of low currents, the vehicle is connected to part of the HV rechargeable battery and is supplied from a segment of the high-voltage battery. The same also applies to the failure of the DC/DC converter.

The segment comprising the HV battery is sufficient for permanent supply of the closed-circuit currents or short-term supply of the operating currents since, for example, the lithium rechargeable batteries of the HV battery generally have a higher capacity than lead-acid rechargeable batteries.

The switchover can take place, as illustrated in FIG. 1, by means of a simple relay or similar switching technology, for example switching contactor or electronic semiconductor switching elements. A precondition for this can be that a HV battery with a tap or a plurality of series circuits comprising individual cells is provided.

The switchover ideally takes place automatically as soon as the DC/DC converter provides sufficient voltage to supply the vehicle electrical distribution system.

Owing to the fact that the high-voltage battery has a dual use, there is no longer a need for the low-voltage battery, for example 12 volts, or the low-voltage rechargeable battery.

Technical effects:
Flexibility: The energy from the high-voltage battery can be connected or distributed wherever it is required at that time, depending on the situation.
Higher capacity in the low-voltage range: The reliability of transportation means is thus significantly increased.
Simplified vehicle design and weight reduction: The lead-acid rechargeable battery can be dispensed with completely and therefore approximately 10 kg in weight and a volume of more than 5 liters.

The above-described properties, features and advantages of this invention and the way in which they are achieved will become clearer and more easily understandable in connection with the following description of the exemplary embodiments. If the term “can” is used in this application, this indicates both the technical possibility and the actual technical implementation.

### BRIEF DESCRIPTION

Some of the embodiments will be described in detail, with reference to the following figures, wherein like designations denote like members, wherein:

FIG. 1 shows an electric car with full supply from a high-voltage rechargeable battery;

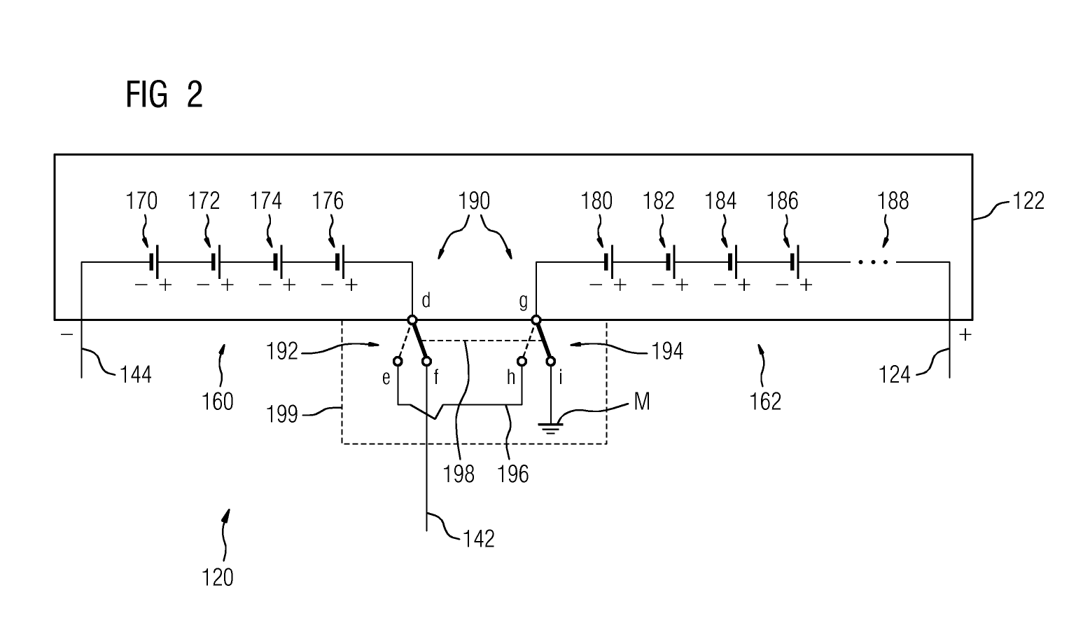

FIG. 2 shows a high-voltage rechargeable battery comprising a twin changeover switch;

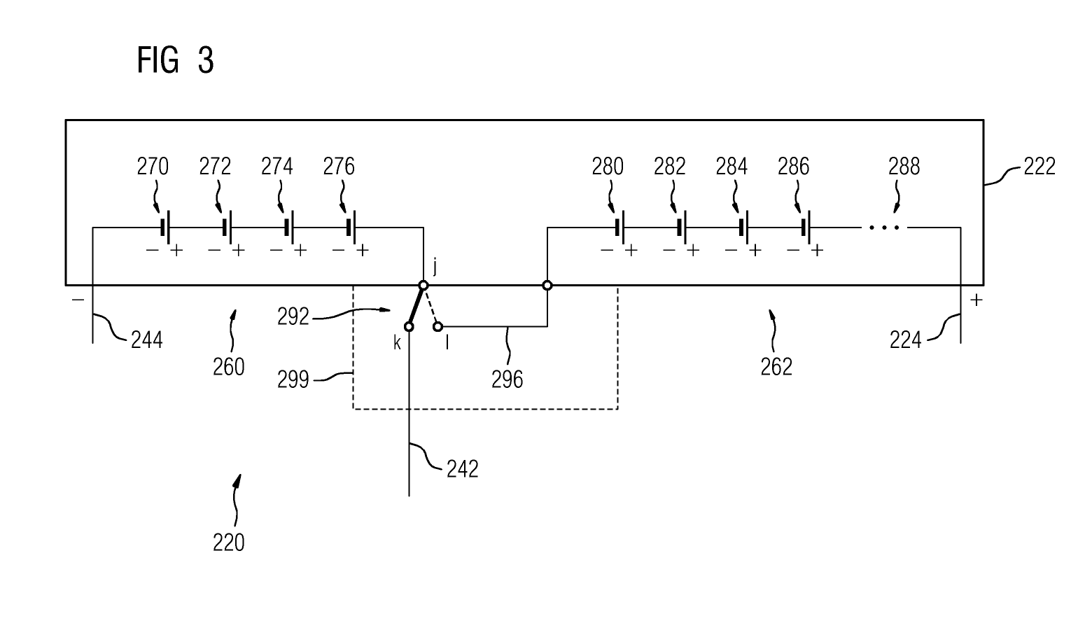

FIG. 3 shows a high-voltage rechargeable battery with a single changeover switch;

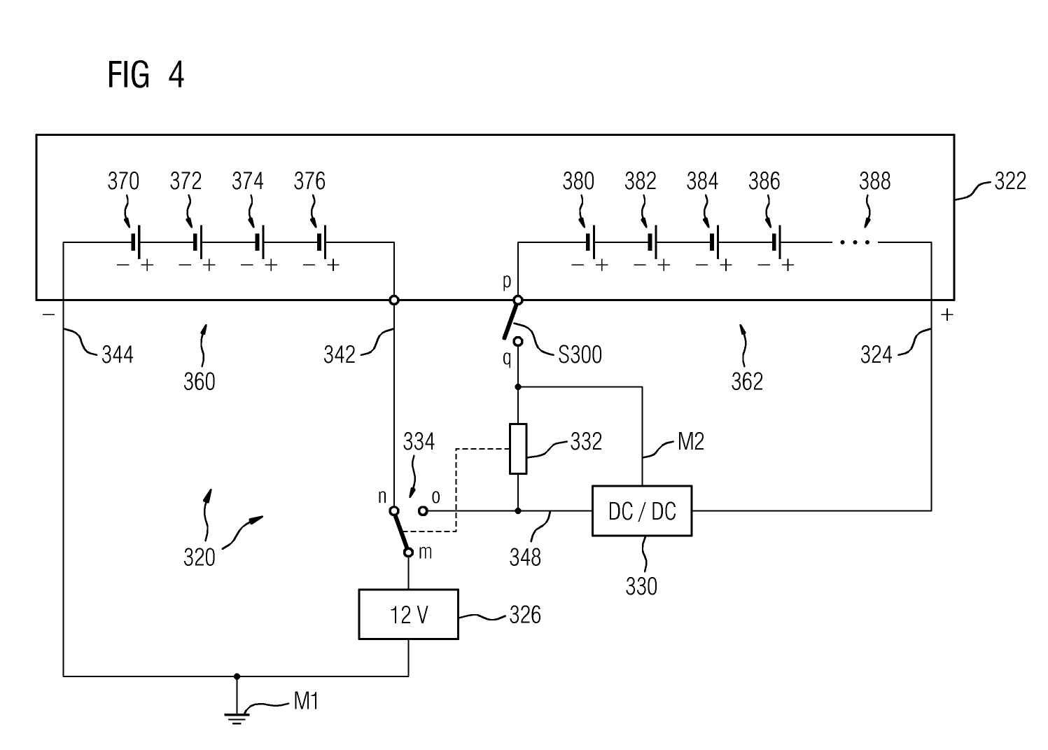

FIG. 4 shows a high-voltage rechargeable battery comprising a low-voltage part and a high-voltage part which are completely disconnected from one another; and

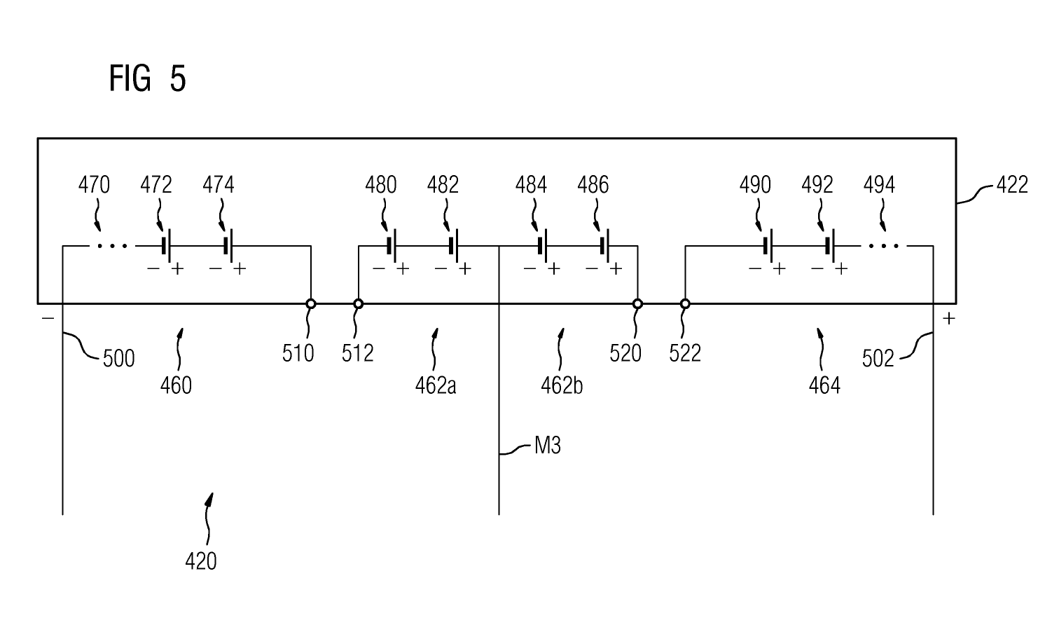

FIG. 5 shows a high-voltage rechargeable battery having a symmetrical high voltage.

### DETAILED DESCRIPTION

FIG. 1 shows an electric car 10 or another electric transportation means with full supply from a high-voltage rechargeable battery, i.e. there is no additional low-voltage rechargeable battery.

The electric vehicle 10 has four wheels (not illustrated), for example, and comprises:
a central control unit 12,
a converter 14,
an electric motor 16, and
a DC voltage supply 20.

The central control unit 12 comprises, for example, a microprocessor or a microcontroller, which executes commands stored in a memory and in the process effects the control functions for controlling the electric car 10.

The converter 14 comprises, for example, a plurality of half-bridges comprising electronic switching elements, for example three half-bridges in the case of a three-phase asynchronous motor 16. Full-bridges can also be used instead of the half-bridges. The center taps of the bridges are connected to the motor 16. The half-bridges are positioned between the high voltage of the high-voltage rechargeable battery 22 or of the high-voltage battery 22 and ground M, for example.

The electric motor 16 is, for example, an asynchronous motor or a synchronous motor. DC motors can also be used. The electric motor and/or the converter can be operated in a known manner.

The voltage supply 20 comprises a high-voltage rechargeable battery 22 or a rechargeable battery. A driving electrical system 24 is connected to a high-voltage connection of the high-voltage rechargeable battery 22. The driving electrical system 22 can be disconnected from the high-voltage rechargeable battery by switching elements (not illustrated), for example.

The driving electrical system 24 is symbolized only by a line in FIG. 2, but is branched in the case of a real electric vehicle 10. The operating voltage in the driving electrical system 24 is greater than 100 volts. In the case of a non-symmetrical electrical system, the operating voltage on the driving electrical system 24 is greater than 200 volts or even greater than 300 volts.

The converter 14 and therefore also the electric motor 16 can be operated on the driving electrical system 24.

The high-voltage rechargeable battery 22 can be charged via a charging unit (not illustrated), for example on a public electrical supply grid with an AC voltage or with a DC voltage generated from such a grid, in particular in a quick-charging operation, i.e. with charging times of less than 30 minutes or less than 15 minutes. Alternatively, the discharged high-voltage rechargeable battery 20 can be replaced by a fully charged high-voltage rechargeable battery at a rechargeable battery replacement station.

A vehicle electrical distribution system 26 has, for example, an operating voltage of less than 50 volts, for example 12 volts, 24 volts or 48 volts in the exemplary embodiment. The vehicle electrical distribution system 26 feeds, for example, the control unit 12 and other electrical equipment of the electric vehicle 10, for example the lighting.

The voltage supply 20 furthermore comprises:
a voltage converter 30,
a relay coil 32,
a relay changeover switch 34,
a ground line 40 which conducts ground potential M, and
lines 44 to 55.

The voltage converter 30 is, for example, a DC/DC converter which can convert an input voltage of several hundred volts, for example of 800 volts, into a lower output voltage or vehicle electrical distribution system voltage, in particular again a DC voltage. In the exemplary embodiment, the vehicle electrical distribution system voltage is 12 volts, for example. The input of the voltage converter 30 is connected to the high-voltage connection, in this case the positive terminal, of the high-voltage rechargeable battery 22. The output of the voltage converter 30 is connected to a line 48, which can be connected to the vehicle electrical distribution system 26 with the aid of the relay changeover switch 34. In addition, the voltage converter 30 has a connection to the ground potential M via a line 46.

The relay coil 32 is connected to the line 48 via a line 49 and to ground M via a line 50. The relay changeover switch 34 activated by the relay coil 32 has three switch contacts a, b, c, wherein the switch contact a is a central contact, which is active in both switch positions or via which a current flows in both switch positions.

The switch contact b is connected to the line 48 and forms a working contact, i.e. the switch contact b is connected to the central contact a when the relay is activated.

The switch contact c is the normally-closed contact, i.e. in the de-energized state or at low voltages at the relay coil 32, there is an electrically conductive connection between the switch contact a and the switch contact c.

Therefore, when the relay 32, 34 is not activated, the vehicle electrical distribution system 26 is fed from a low-voltage connection 42 at the high-voltage rechargeable battery 22 via a line 55, which is connected to the switch contact c.

When the relay 32, 34 is activated, the vehicle electrical distribution system 26 is fed from a high-voltage connection of the high-voltage rechargeable battery 22 via the voltage converter 30, on the other hand.)

The following are furthermore connected to the ground line 40:
the negative terminal or the ground terminal of the high-voltage rechargeable battery 22 via a line 44, and
also the vehicle electrical distribution system 26.

In all of the exemplary embodiments in FIGS. 1 to 5, a voltage of less than 50 volts is present at the connection 42. The internal design of the high-voltage rechargeable battery 22 can be selected differently, wherein four variants are explained below with reference to FIGS. 2 to 5. In the simplest case, the connection 42 is merely a tap between two individual cells of a series circuit comprising all of the individual cells of the high-voltage rechargeable battery.

The voltage ratios in the voltage supply 20 are illustrated by arrows 56 to 58:
the arrow 56 symbolizes the high voltage at the high-voltage output of the high-voltage rechargeable battery 22 or at the driving electrical system 24,
the arrows 57, 58 symbolize a vehicle electrical distribution system voltage 12 V (Bat), which is present at the low-voltage connection 42 of the high-voltage rechargeable battery 22,
the arrow 59 shows the low voltage at the output of the voltage converter 30, 12 volts (DC) in the example.

All of the voltages of the arrows 56 to 58 apply with respect to ground M.

The ground connection of the high-voltage rechargeable battery 22 is referred to as the first connection in some claims. The high-voltage connection or the positive terminal of the high-voltage rechargeable battery 22 is referred to as the second connection in the claims. The connection 42 is referred to as the third connection of the high-voltage rechargeable battery 22 in the claims.

The vehicle electrical distribution system 26 can be disconnected from the contact a and possibly also from the ground line 40, depending on the position of a starter key, for example by means of switching units (not illustrated).

FIG. 2 shows a high-voltage rechargeable battery 122 comprising a twin changeover switch 190. A voltage supply 120 comprising the high-voltage rechargeable battery 122 can be used in the electric car 10, wherein the voltage supply 20 shown in FIG. 1 comprises the high-voltage rechargeable battery 122 instead of the high-voltage rechargeable battery 22.

The high-voltage rechargeable battery or the rechargeable battery 122 comprises:
a positive terminal 124,
a negative terminal 144, which conducts ground potential,
a first series circuit 160 comprising four individual cells 170 to 176, for example,
a second series circuit 162 comprising more than four individual cells 180 to 188, and
the twin changeover switch 190.

The positive terminal or the driving electrical system 124 is located at the positive terminal of the last cell of the second series circuit 162. The driving electrical system 124 corresponds to the driving electrical system 24 shown in FIG. 1. The negative terminal 144 is located at the negative terminal of the first cell 170 of the first series circuit 160. The negative terminal 144 corresponds to the negative terminal or the line 44 shown in FIG. 1.

Accordingly, the converter 14 and the DC/DC converter 30 are positioned between the ground terminal 144 or M, the switch contact i, and the positive terminal 124.

The first series circuit 160 comprises, in the case of lithium-ion cells, the four individual cells or cells 170 to 176, for example, wherein the positive terminal of the cell 170 is connected to the negative terminal of the cell 172, the positive terminal of the cell 172 is connected to the negative terminal of the cell 174, etc. At other cell voltages or other vehicle electrical distribution system voltages, a different number of cells is used in the first series circuit 160 in order to achieve the vehicle electrical distribution system voltage.

The second series circuit 162 comprises, in the case of lithium-ion cells, approximately 200 individual cells or cells 180 to 188, for example, wherein the positive terminal of the cell 180 is connected to the negative terminal of the cell 182, the positive terminal of the cell 182 is connected to the negative terminal of the cell 184, etc. At other cell voltages or other driving electrical system voltages, a different number of cells is used in the second series circuit 162 in order to achieve the required driving electrical system voltage.

The twin changeover switch 190 comprises a first changeover switch 192 and a second changeover switch 194.

The changeover switch 192 comprises three switch contacts d, e, f, wherein the switch contact d is the central connection. The central connection d is connected to the positive terminal of the cell 176. The switch contact e is connected to a connecting line 196. The switch contact f is connected to a line 142, which corresponds to the line 42.

The changeover switch 194 likewise comprises three switch contacts g, h, i, wherein the switch contact g is the central connection. The central connection g is connected to the negative terminal of the cell 180. The switch contact h is connected to the connecting line 196. The switch contact i is connected to the line 144 or to ground M. Other circuitry for the contact i is likewise possible.

In a starting switch position, the contacts d and f and the contact g and i are connected. Thus, the vehicle electrical distribution system 26 can be fed directly via the line 142, i.e. without the use of the voltage converter 30. However, the voltage converter 30 can also operate in this switch position, so that switchover to contact b of the changeover switch 34 takes place as soon as the output voltage of the voltage converter is present.

A control unit of the voltage converter 30 or a voltage supply unit of the voltage converter 30 can accordingly first be supplied via the line 142.

In a driving switch position, the contacts d and e and the contacts g and h are connected. Thus, the vehicle electrical distribution system 26 can no longer be fed directly via the line 142, i.e. without the use of the voltage converter 30. Therefore, the system should only be switched into the driving position when the voltage converter 30 can supply voltage entirely to the vehicle electrical distribution system 26, for example after at least 500 milliseconds or at least 1 second in the start position. However, the voltage converter 30 can operate in this driving switch position, so that switchover to contact b of the changeover switch 34 can take place as soon as the output voltage of the voltage converter is present. A control unit of the voltage converter 30 or a voltage supply unit of the voltage converter 30 can accordingly be supplied via the voltage converter 30 itself and the vehicle electrical distribution system 26.

In the driving position, the two series circuits 160 and 162 are connected in series for their part via the connecting line 196, so that the entire voltage of the high-voltage rechargeable battery 122 is available at the positive terminal 124 or at the driving electrical system. Alternatively, the voltage of the series circuit 162 can also only be used, which will be explained in more detail below with reference to FIG. 4.

The two changeover switches 190, 192 are coupled via a mechanical coupling 198. The twin changeover switch 190 can be manually activatable. As an alternative or in addition, electronic activation can take place, for example via a relay coil.

A rechargeable battery housing 199 can comprise the twin changeover switch 190. Alternatively, the twin changeover switch 190 is arranged outside the rechargeable battery housing 199.

In another example, an electronic switching unit using semiconductor switching elements is used instead of the twin changeover switch 190.

If the vehicle 10 is parked, the high-voltage rechargeable battery 122 can be disconnected, for example from the driving electrical system and from the vehicle electrical distribution system, both at the positive terminal 124 and at the negative terminal 144 by switching units (not illustrated), for example. Alternatively, only disconnection from the driving electrical system takes place, for example on the side of the positive terminal 124.

In the circuit shown in FIG. 2, the twin changeover switch 190 can be switched into the initial position illustrated in FIG. 2 at any time during driving, in which initial position the vehicle electrical distribution system is supplied by the first series circuit 160, for example if the DC/DC converter fails. The second series circuit 162 can in this case feed the converter 14 and therefore also the traction motor.

FIG. 3 shows a high-voltage rechargeable battery 222 comprising a single changeover switch 292. A voltage supply 220 comprising the high-voltage rechargeable battery 222 can be used in the electric car 10, wherein the voltage supply 20 shown in FIG. 1 comprises the high-voltage rechargeable battery 222 instead of the high-voltage rechargeable battery 22.

The high-voltage rechargeable battery or the rechargeable battery 222 comprises:
a positive terminal 224,
a negative terminal 244, which conducts ground potential,
a first series circuit 260 comprising four individual cells 270 to 276, for example,
a second series circuit 262 comprising more than four individual cells 280 to 288, and
the changeover switch 292.

The positive terminal or the driving electrical system 224 is located at the positive terminal of the last cell of the second series circuit 262. The driving electrical system 224 corresponds to the driving electrical system 24 shown in FIG. 1. The negative terminal 244 is located at the negative terminal of the first cell 270 of the first series circuit 260. The negative terminal 244 corresponds to the negative terminal or the line 44 shown in FIG. 1.

Accordingly, the converter 14 and the DC/DC converter 30 are located between the ground terminal 244 or M and the positive terminal 224.

The first series circuit 260 comprises, in the case of lithium-ion cells, the four individual cells 270 to 276, for example, wherein the positive terminal of the cell 270 is connected to the negative terminal of the cell 272, the positive terminal of the cell 272 is connected to the negative terminal of the cell 274, etc. At other cell voltages or other vehicle electrical distribution system voltages, a different number of cells is used in the first series circuit 260 in order to achieve the vehicle electrical distribution system voltage.

The second series circuit 262 comprises, in the case of lithium-ion cells, approximately 200 individual cells 280 to 288, for example, wherein the positive terminal of the cell 280 is connected to the negative terminal of the cell 282, the positive terminal of the cell 282 is connected to the negative terminal of the cell 284, etc. At other cell voltages or other driving electrical system voltages, a different number of cells is used in the second series circuit 262 in order to achieve the required driving electrical system voltage.

The changeover switch 292 comprises three switch contacts j, k, l, wherein the switch contact j is the central connection. The central connection j is connected to the positive terminal of the cell 276. The switch contact k is connected to a line 242, which corresponds to the line 42. The switch contact 1 is connected to a connecting line 296. The other end of the connecting line 296 is connected to the negative terminal of the cell 280.

In a park switch position, the contacts j and k are connected. Thus, the vehicle electrical distribution system 26 can be fed directly via the line 242, i.e. without the use of the voltage converter 30. The voltage converter 30 cannot operate in this switch position so that no switchover to contact b of the changeover switch 34 takes place either. The converter 14 is at zero potential in the park switch position because series circuits 260 and 262 are not connected via the connections j and l.

During starting, the changeover switch 292 is switched into the other switch position, in which the contacts or connections j and l are connected. After the switchover, the voltage converter 30 can operate, so that switchover to contact b of the changeover switch 34 takes place as soon as the output voltage of the voltage converter 30 is present and stable. A control unit of the voltage converter 30 or a voltage supply unit of the voltage converter 30 can still be supplied via the line 242 during switchover, for example, wherein a buffer capacitor of sufficient capacitance is used.

In the driving position, the two series circuits 260 and 262 are for their part connected in series via the connecting line 296 so that the total voltage of the high-voltage rechargeable battery 222 is available at the positive terminal 224 or at the driving electrical system. Alternatively, only the voltage of the series circuit 262 can also be used, which will be explained in more detail below with reference to FIG. 4.

The changeover switch 292 can be manually activatable. Alternatively or in addition, electronic activation can also take place, for example via a relay coil.

A rechargeable battery housing 299 can contain the changeover switch 292. Alternatively, the changeover switch 292 is arranged outside the rechargeable battery housing 299.

In another example, an electronic switching unit using semiconductor switching elements is used instead of the changeover switch 292.

If the vehicle 10 is parked, the high-voltage rechargeable battery 222 can be disconnected, for example from the driving electrical system or from the vehicle electrical distribution system, by switching units (not illustrated) both at the positive terminal 224 and at the negative terminal 244, for example. Alternatively, only disconnection from the driving electrical system takes place, for example on the side of the positive terminal 224. Further alternatively or in addition, the disconnection by the changeover switch 292 is sufficient.

In the circuit shown in FIG. 3, it is not possible simply to switch to the initial position illustrated in FIG. 3 during driving because the second series circuit 262 can in this case not feed the converter 14 and therefore also the traction motor on its own. Thus, a defective DC/DC converter can in this case only be compensated for a short period of time, for example for coming to a standstill, by the vehicle electrical distribution system being connected to the series circuit 260 again. However, the circuit is simple and also enables disconnection of the converter 14 or the DC/DC converter 30 from the high voltage during parking.

FIG. 4 shows a high-voltage rechargeable battery 322 comprising a low-voltage part 360 and a high-voltage part 362 which are completely disconnected from one another, at least apart from a charging mode of the cells of the rechargeable battery. A voltage supply 320 comprising the high-voltage rechargeable battery 322 can be used in the electric car 10. The low-voltage part 360 corresponds to the previously used lead-acid battery. The high-voltage part 362 corresponds to the previously used separate high-voltage rechargeable battery.

The high-voltage rechargeable battery or the rechargeable battery 322 comprises:
a positive terminal 324,
a negative terminal 344, which conducts ground potential M1,
a first series circuit 360 comprising four individual cells 370 to 376, for example, and
a second series circuit 362 comprising more than four individual cells 380 to 388.

The positive terminal or the driving electrical system 324 is located at the positive terminal of the last cell of the second series circuit 362. The negative terminal or ground terminal of the driving electrical system is located at the connection q of the switch S300, for example, or if this switch is not being used, at the negative terminal of the cell 380. The driving electrical system 324 corresponds in terms of its operation to the driving electrical system 24 shown in FIG. 1.

The negative terminal 344 of the vehicle electrical distribution system is located at the negative terminal of the first cell 370 of the first series circuit 360. The negative terminal 344 corresponds to the negative terminal or the line 44 shown in FIG. 1, i.e. inter alia the connection of a vehicle electrical distribution system 326, which corresponds to the vehicle electrical distribution system 36.

The first series circuit 360 comprises, in the case of lithium-ion cells, the four individual cells 370 to 376, for example, wherein the positive terminal of the cell 370 is connected to the negative terminal of the cell 372, the positive terminal of the cell 372 is connected to the negative terminal of the cell 374, etc. At other cell voltages or other vehicle electrical distribution system voltages, a different number of cells is used in the first series circuit 360 in order to achieve the vehicle electrical distribution system voltage.

The second series circuit 362 comprises, in the case of lithium-ion cells, approximately 200 individual cells 380 to 388, for example, wherein the positive terminal of the cell 380 is connected to the negative terminal of the cell 382, the positive terminal of the cell 382 is connected to the negative terminal of the cell 384, etc. At other cell voltages or other driving electrical system voltages, a different number of cells is used in the second series circuit 362 in order to achieve the required driving electrical system voltage.

The positive terminal of the last cell 376 of the first series circuit 360 is passed out of the rechargeable battery 322. Thus, the first series circuit 360 forms a low-voltage part of the high-voltage rechargeable battery 322.

A line 342 which leads to a switch contact n of a changeover switch 334 is connected to the positive terminal of the cell 376 or to the end of the first series circuit 360. The changeover switch 334 has the same function as the changeover switch 34 (see FIG. 1), i.e. switchover of the vehicle electrical distribution system between the connection 342 and the voltage converter 330.

A switch contact o of the changeover switch 334 is connected to an output of the voltage converter 330, which corresponds in terms of its function to the function of the voltage converter 30 (see FIG. 1). The input of the voltage converter 330 is connected to the positive terminal or to the driving electrical system 324. The voltage converter 330 has a ground connection, which is connected to the negative terminal of the cell 380 and therefore to the second series circuit 362 via a ground line M2 directly or via a switch S300.

The switch S300 has two switch contacts p and q. The switch contact p is connected to the line M2. The switch contact q is connected to the negative terminal of the cell 380, which is passed out of the high-voltage rechargeable battery 322.

The negative terminal of the first cell 380 of the second series circuit 362 is therefore likewise passed out of the rechargeable battery 322. Thus, the second series circuit 360 forms a high-voltage part of the high-voltage rechargeable battery 322.

A relay coil 332 corresponding to the relay coil 32 is connected between the line M2 and the line 348, for example, so that the relay and therefore the changeover switch 334 switches to the switch contact o as soon as the output voltage of the voltage converter 330 is high enough. Thus, the vehicle electrical distribution system 326 is then disconnected from the line 342 then and connected to the output of the voltage converter 330.

During charging, separate chargers can be used for the series circuits 360 and 362. Alternatively, the series circuits 360 and 362 are only connected for charging.

In another example, an electronic switching unit using semiconductor switching elements is used instead of the changeover switch 334. Likewise, a semiconductor switching unit can be used instead of the switch S300.

If the vehicle 10 is parked, the high-voltage rechargeable battery 322 can be disconnected, in particular from the vehicle electrical distribution system 326 and from the driving electrical system 324 or only from the driving electrical system, by switching elements (not illustrated). Alternatively, disconnection of the driving electrical system by the switch S300 is sufficient.

Alternatively, the rechargeable battery 322 can also be operated with only one ground M, wherein the negative terminal of the cell 380 is fixedly connected to the negative terminal of the cell 370, for example.

During starting, for example, the switch S300 is activated so that the converter 14 and the DC/DC converter are connected to the high-voltage rechargeable battery 362. After some time, the changeover switch 334 then switches to the switch position o by means of the relay coil 332 or in some other way. A defect of the DC/DC converter can be compensated for since then the changeover switch 334 again switches to the switch position n and the driving electrical system continues to be supplied a high voltage via the series circuit 362.

FIG. 5 shows a high-voltage rechargeable battery 422 having a symmetrical high voltage. The high-voltage rechargeable battery 422 is part of a voltage supply 420, which can be inserted into an electric transportation means, in particular into an electric vehicle 10, which does not comprise a separate rechargeable battery for a vehicle electrical distribution system.

The high-voltage rechargeable battery 422 or the rechargeable battery 422 comprises:
a negative terminal 500,
a positive terminal 502,
a ground M3,
a first series circuit 460,
a second series circuit 462a, 462b, and
a third series circuit 464.

The first series circuit 460 comprises, in the case of lithium-ion cells, approximately 100 individual cells 470 to 474, for example, wherein in each case the positive terminal of a cell is connected to the negative terminal of the adjacent cell; see by way of example the positive terminal of the cell 472 with the negative terminal of the cell 474, etc. At other cell voltages or other driving electrical system voltages, a different number of cells is used in the first series circuit 460 to achieve the driving electrical system voltage. The positive terminal of the cell 474 is passed out of the rechargeable battery 422, for example; see connection 510. Alternatively, the positive terminal of the cell 474 can be passed to a switching unit in the rechargeable battery 422.

The second series circuit 462a, 462b comprises, in the case of lithium-ion cells, for example, the four individual cells 480 to 486, wherein in each case the positive terminal of the cell 480 is connected to the negative terminal of the cell 482, the positive terminal of the cell 482 is connected to the negative terminal of the cell 484, etc. At other cell voltages or other vehicle electrical distribution system voltages, a different number of cells is used in the second series circuit 462a, 462b to achieve the vehicle electrical distribution system voltage. The ground M3 can be tapped between the cells 482 and 484. The ground M3 can be passed out of the rechargeable battery. Alternatively, the ground M3 can be connected to a switching unit, which is in the interior of the rechargeable battery 422. The negative terminal of the cell 480 can be passed out of the rechargeable battery 422, see connection 512. The positive terminal of the cell 486 can likewise be passed out of the rechargeable battery 422; see connection 520. Alternatively, the negative terminal of the cell 480 and/or the positive terminal of the cell 486 can be connected to a switching unit or to a plurality of switching units, which are arranged in the interior of the rechargeable battery 422.

The third series circuit 464 comprises, in the case of lithium-ion cells, likewise approximately 100 individual cells 490 to 494, for example, wherein in each case the positive terminal of a cell is connected to the negative terminal of the adjacent cell; see by way of example the positive terminal of the cell 490 with the negative terminal of the cell 492, etc. At other cell voltages or other driving electrical system voltages, a different number of cells is used in the third series circuit 464 in order to achieve the driving electrical system voltage. The negative terminal of the cell 490 is passed out of the rechargeable battery 422, for example; see connection 522. Alternatively, the negative terminal of the cell 490 can be passed to a switching unit in the rechargeable battery 422. The number of cells in the first series circuit 460 and the number of cells in the third series circuit 464 is preferably the same.

The positive terminal of the cell 474 is passed out of the rechargeable battery 422, for example. Alternatively, the positive terminal of the cell 474 can be passed to a switching unit in the rechargeable battery 422.

The rechargeable battery 422 can be provided with the following types of wiring, for example:
As shown in FIG. 2, said rechargeable battery can be connected to a first twin changeover switch at the connections 510 and 512 and to a second twin changeover switch at the connections 520 and 522, wherein a negative line and a positive line of the vehicle electrical distribution system are tapped at the connections 512 and 520. In the driving mode, all of the series circuits 460 to 464 are connected.
As shown in FIG. 3, said rechargeable battery is connected to a first changeover switch at the connection 512 and to a second changeover switch at the connection 520, wherein a negative line and a positive line of the vehicle electrical distribution system are tapped at the connections 512 and 520. In the driving mode, all of the series circuits 460 to 464 are connected.
As shown in FIG. 4, said rechargeable battery is connected to a high-voltage part 470 to 474 and 490 and 494 and a low-voltage part 480 to 486 which are disconnected from one another, wherein the connections 510 and 522 can be connected to one another as ground of the high-voltage part.

In other exemplary embodiments, the low-voltage part can also optionally be selected from two series circuits, which is possible in all mentioned variants, i.e. as shown in FIGS. 2, 3, 4 and 5 or in accordance with the modifications in FIG. 5, which have been explained with reference to FIGS. 2, 3 and 4.

The converter is connected between the lines 500 and 502, for example.

In all explained variants with respect to FIG. 5, the vehicle electrical distribution system can also be connected only on the left-hand side or only on the right-hand side of the ground potential M3, for example.

The mentioned switching units can be arranged both in the rechargeable battery 422 and outside the rechargeable battery 422.

The exemplary embodiments are not true to scale and are not restrictive. Modifications within the scope of the activities of a person skilled in the art are possible. Although the invention has been described and illustrated in more detail by the preferred exemplary embodiment, the invention is not restricted by the disclosed examples and other variations can be derived from these by a person skilled in the art without departing from the scope of protection of the invention. The developments and configurations mentioned in the introductory part can be combined with one another. The exemplary embodiments mentioned in the description of the figures can likewise be combined with one another. Furthermore, the developments and configurations mentioned in the introductory part can be combined with the exemplary embodiments mentioned in the description of the figures.

1. An electric transportation device, in particular an electric vehicle, comprising a rechargeable battery unit comprising a first connection and a second connection to the rechargeable battery unit, wherein, when the rechargeable battery unit is fully charged, a first voltage of at least 200 volts is present between the first connection and the second connection, and comprising a third connection at the rechargeable battery unit, wherein a second voltage which is less than 20% of the first voltage, is tapped off at the third connection, and a vehicle electrical distribution system, which is connected to the third connection or is connectable to said third connection via a first switching unit of the transportation means.

2. The electric transportation device as claimed in claim 1, comprising a voltage converter, which is connected on the input side to the second connection or is connectable thereto via a second switching unit of the transportation means.

3. The electric transportation device as claimed in claim 2, wherein the first switching unit comprises a first changeover switching unit, whose central connection is connected to the vehicle electrical distribution system, whose second connection is connected to the third connection of the rechargeable battery unit, and whose third connection is connected to an output of the voltage converter.

4. The electric transportation device as claimed in claim 3, wherein the first changeover switching unit is part of an electrically actuatable switching unit.

5. The transportation device as claimed in claim 4, wherein the first changeover switching unit, in a first switching mode, connects the vehicle electrical distribution system to the third connection of the rechargeable battery unit, and wherein the first changeover switching unit, in a second switching mode, connects the vehicle electrical distribution system to the output of the voltage converter.

6. The electric transportation device as claimed in claim 1, wherein a first central connection of a twin changeover switching unit is connected to a first series circuit comprising individual cells of the rechargeable battery unit, and wherein a second central connection of the twin changeover switching unit is connected to a second series circuit comprising individual cells of the rechargeable battery unit, wherein the second series circuit comprises different individual cells than the first series circuit.

7. The electric transportation device as claimed in claim 6, wherein a first connection of the first changeover switching unit of the twin changeover switching unit is fixedly connected to a first connection of the second changeover switching unit of the twin changeover switching unit, wherein, in a first switching mode, the first connection of the first changeover switching unit of the twin changeover switching unit, is connected to the first central connection of the twin changeover switching unit, and wherein, in the first switching mode, the first connection of the second changeover switching unit of the twin changeover switching unit is also connected to the second central connection of the twin changeover switching unit (190).

8. The electric transportation device as claimed in claim 7, wherein a second connection of the first changeover switching unit of the twin changeover switching unit is connected to the third connection of the rechargeable battery unit or forms the third connection of the rechargeable battery unit.

9. The electric transportation device as claimed in claim 8, wherein, in a second switching mode of the twin changeover switching unit, the second connection of the first changeover switching unit of the twin changeover switching unit is connected to the first central connection of the twin changeover switching unit, and wherein, in the second switching mode of the twin changeover switching unit, the second connection of the second changeover switching unit of the twin changeover switching unit is connected to the second central connection of the twin changeover switching unit.

10. The electric transportation device as claimed in claim 1, wherein a central connection of a changeover switching unit is connected to a first series circuit comprising individual cells of the rechargeable battery unit, wherein a first connection of the changeover switching unit is connected to the third connection of the rechargeable battery unit or forms the third connection of the rechargeable battery unit, and wherein a second connection of the changeover switching unit is connected to a second series circuit comprising individual cells of the rechargeable battery unit, and wherein the second series circuit comprises different individual cells than the first series circuit.

11. The electric transportation device as claimed in claim 1, wherein the rechargeable battery unit comprises a first series circuit comprising individual cells of the rechargeable battery unit,
wherein the first series circuit is connected to the third connection of the rechargeable battery unit, wherein the rechargeable battery unit comprises a second series circuit comprising individual cells of the rechargeable battery unit, wherein the second series circuit comprises different individual cells than the first series circuit, wherein one end of the second series circuit is connected to the second connection of the rechargeable battery unit, and wherein preferably the rechargeable battery unit and the transportation means are free of a switching unit which connects the first series circuit to the second series circuit, in particular apart from a charging mode.

12. The electric transportation device as claimed in claim 6, wherein the first series circuit comprising individual cells is connected to a ground line of the transportation means.

13. The electric transportation device as claimed in claim 6, wherein at least three series circuits comprising individual cells of the rechargeable battery unit are contained in the rechargeable battery unit, wherein connections of the series circuits are passed to the outside or can be disconnected from one another and/or interconnected to one another in the interior of the rechargeable battery unit.

14. A method for operating an electric transportation device or an electric vehicle, in particular as claimed in claim 1, wherein, in a first operating mode, a vehicle electrical distribution system is operated at a connection of a rechargeable battery unit, wherein only a partial voltage of the rechargeable battery unit is present at the connection,
and wherein, in a second operating mode, the vehicle electrical distribution system is fed from a voltage converter, which is connected to a further connection of the rechargeable battery unit, wherein a voltage which is greater than the partial voltage is present at the further connection.

15. A rechargeable battery, in particular a rechargeable battery unit as used in a transportation means or an electric vehicle as claimed claim 1, comprising a first connection and a second connection at the rechargeable battery, wherein, when the rechargeable battery is fully charged, a first voltage of at least 200 volts is present between the first connection and the second connection, a third connection at the rechargeable battery, wherein a second voltage which is less than 20% of the first voltage can be tapped off at the third connection.
